(19) United States
(12) Patent Application Publication
(10) Pub. No.: US 2025/0354896 A1
(43) Pub. Date: Nov. 20, 2025

(54) Controlled Impact Portable Rail Device

(71) Applicant: Transportation Technology Center, Inc. d/b/a MxV Rail, Pueblo, CO (US)

(72) Inventors: Brian Eric Smith, Pueblo West, CO (US); Matthew Ward Witte, Tecumseh, MI (US); Yuqing Zeng, Pueblo, CO (US); Nathan Jeremiah Stoehr, Vinton, VA (US)

(73) Assignee: Transportation Technology Center, Inc. d/b/a MxV Rail, Pueblo, CO (US)

(21) Appl. No.: 19/171,258

(22) Filed: Apr. 5, 2025

Related U.S. Application Data
(60) Provisional application No. 63/647,739, filed on May 15, 2024.

(51) Int. Cl. G01M 17/10

(52) U.S. Cl. CPC G01M 17/10

(57) ABSTRACT

A portable device for removable attachment to a rail has a thin upper surface contoured to conform with the head of a rail, and a simulated defect in the upper surface to exert a predetermined impact load on the wheel of a rail vehicle rolling over the device on a rail. An attachment mechanism removably secures the device to a rail with the upper surface of the device covered a selected portion of the rail head.

### RELATED APPLICATION

The present application is based on and claims priority to the Applicant's U.S. Provisional Patent Application 63/647,739, entitled “Controlled Impact Portable Rail Device,” filed on May 15, 2024.

### BACKGROUND OF THE INVENTION

Field of the Invention. The present invention relates generally to the field of testing equipment and instrumentation for the railroad industry. More specifically, the present invention discloses a portable device for removable attachment to a rail to create a known wheel/rail load.

Statement of the Problem. Railroad rails are subject to a variety of defects, such cracks, surface defects and excessive wear that can create risks to railroad traffic. The prior art includes many instrumentation systems for detecting such rail defects. Many instrumentation systems are carried onboard a test rail vehicle and detect rail defects as the test vehicle rolls along the rail. Other instrumentation systems are configured for on-track use.

In both cases, a need exists to periodically validate or calibrate the performance of such instrumentation by exerting a known wheel/rail load. Preferably, this should be provided by a device that is portable and can be readily secured to a test rail segment at a desired location. In addition, the device should be simple, rugged and relatively inexpensive to manufacture.

Solution to the Problem. The present invention addresses these needs by providing a portable device that can be easily attached to a rail at a desired location. In addition, the present invention can be readily fabricated with vertical profiles to simulate any of a wide variety of rail defects.

The present device is useful as a test standard for validating or calibrating wheel impact load detectors and other on-board or on-track testing devices that may require standardization for use in interchange service. In particular, the present device provides a means to validate wheel impact load detectors commonly used in the railroad industry for indicating wheelset removal during interchange service in North America. The present invention facilitates accurate measurement of wheel/rail dynamic loads and can be applied to both on-board the train and in-track measurement systems. For example, it may be adopted as a standard impulse force input device for validating wheel impact load detectors.

### SUMMARY OF THE INVENTION

This invention provides a portable device for removable attachment to a rail having a thin upper surface contoured to conform with the head of a rail, and a simulated defect in the upper surface to exert a predetermined impact load on the wheel of a rail vehicle rolling over the device on a rail. An attachment mechanism removably secures the device to a rail with the upper surface of the device covered a selected portion of the rail head.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an axonometric view of the present device 20 attached to a railhead 12.

FIG. 2 is a simplified vertical cross-sectional view showing a railroad wheel 50 striking the simulated defect of the present device 20.

FIG. 3 is a graph showing an example of the wheel/rail vertical force resulting from the railroad wheel 50 rolling over the simulated defect in FIG. 2.

FIGS. 4A-4D show vertical cross-sectional views of four embodiments of the simulated defect.

FIG. 5 is a vertical cross-sectional view of the present device 20 on a rail 10.

FIG. 6 is a vertical cross-sectional view of an alternative embodiment the present device 20 with a clamp mechanism 46 secured to the rail 10.

### DETAILED DESCRIPTION OF THE INVENTION

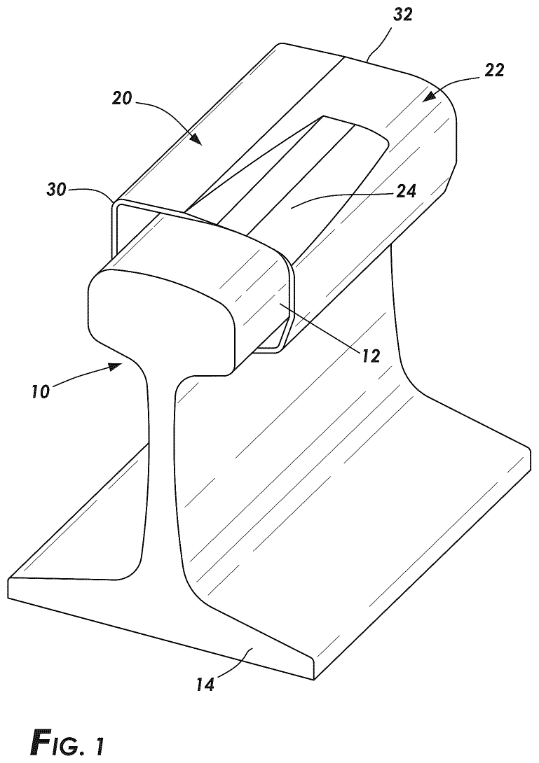

Turning to FIG. 1, an axonometric view is provided showing an embodiment of the present device 20 attached to a rail 10. The thin upper surface 22 of the device 20 is contoured to generally conform with the profile of the rail head 12. The present device 20 can be removably attached to a rail 10 to simulate a wheel defect. The simulated defect in the upper surface 22 exerts a predetermined impact force on the wheel 50 of a rail vehicle rolling over the device 20 on a rail 10. For example, the simulated defect could be a raised bump 26 or ridge on the upper surface 22 of the device 20 to create a controlled wheel/rail impact force at the wheel/rail interface of known magnitude and shape. The impact force can be used as an input for a variety of purposes, such as comparing on-board and roadside impact force measurements, validating wheel impact load detectors, and identifying the status/parameters of track structures, etc.

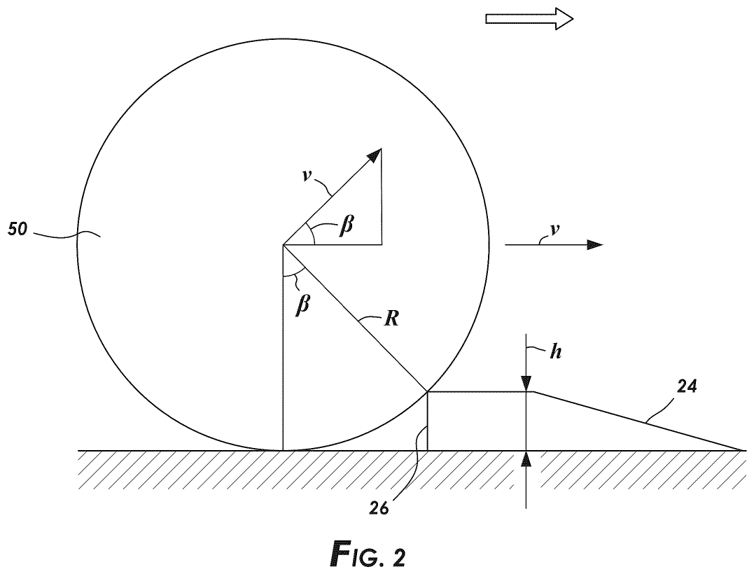

In one embodiment, the simulated defect includes a ramp 24 on the upper surface 22 having a vertical profile to exert a controlled rate of vertical loading of the wheel (e.g., gradual lifting or lowering or an abrupt step). FIG. 2 shows an example of a railroad wheel 50 encountering a simulated defect in the form of an abrupt step 26 followed by a ramp 24 down. FIG. 3 is a graph illustrating the resulting wheel/rail vertical force corresponding to FIG. 2 measured by onboard (instrumented wheelset or IWS) and wayside (high accuracy bi-circuit method) systems. When a wheel 50 passes over the bump up in FIG. 2, the impact force increases nearly linearly with the increase in speed and bump thickness (h). Therefore, we can effectively control the magnitude of the impact force by changing the thickness of the bump or operational speed.

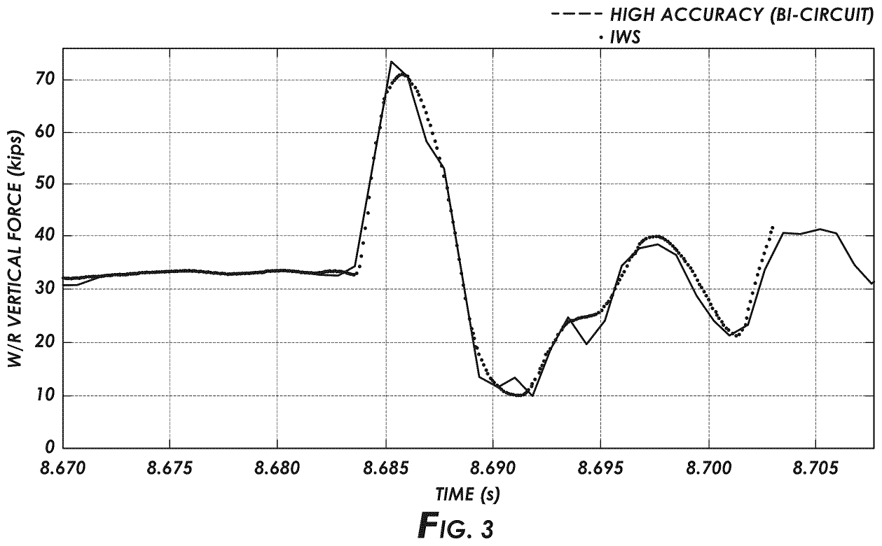

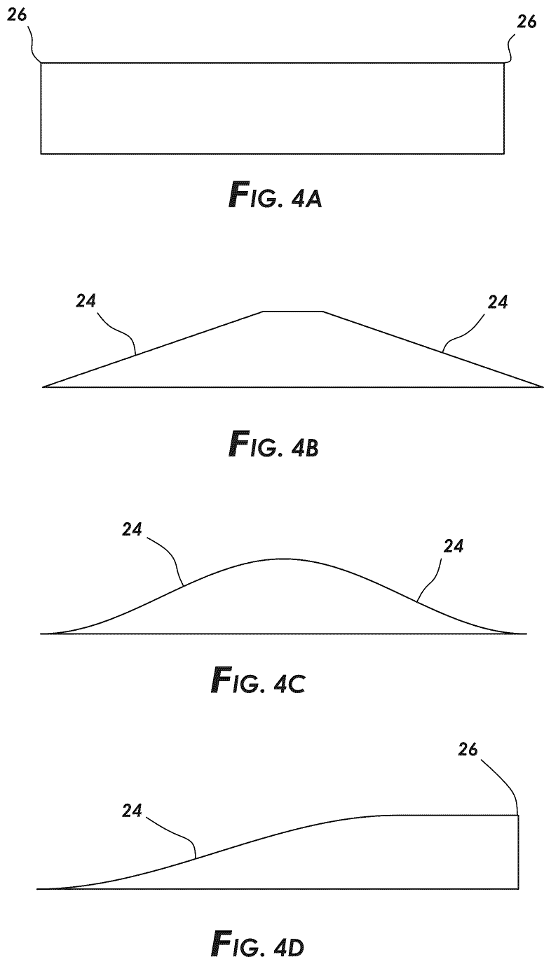

In addition to controlling the magnitude of the impact force, we can also obtain different types of impact forces by varying the thickness and shape of the simulated defect along the upper surface 22 of the device 20. For example, FIGS. 4A-4D illustrate several other possible embodiments of the simulated defect. In the embodiment shown in FIG. 4D, there is a “bump down” when the wheel 50 falls from the bump 26 at the right end of the simulated defect. Initially, the impact force increases with increased speed. However, when the speed exceeds a critical speed, the impact force does not change much, although the maximum impact force continues to increase with bump thickness. In this case, the critical speed is determined by bump thickness and the parameters of the railway vehicle.

The leading edge 30 or trailing edge 32 of the upper surface 22 of the device 20 can be reduced to a nominal thickness to create a contoured ramp 24 extending upward from the rail head with a predetermined slope and height. Alternatively, the device 20 can be formed with raw leading or trailing edges 30, 32 having a predetermined thickness to create an abrupt step up or step down when the rolling wheel 50 enters or exits the device 20, as previously discussed. The ramp-in and ramp-out slope and overall thickness can be selected based on the desired dynamic response of the impulse exerted on the railroad wheel 50 as it passes over the simulated defect at a given speed.

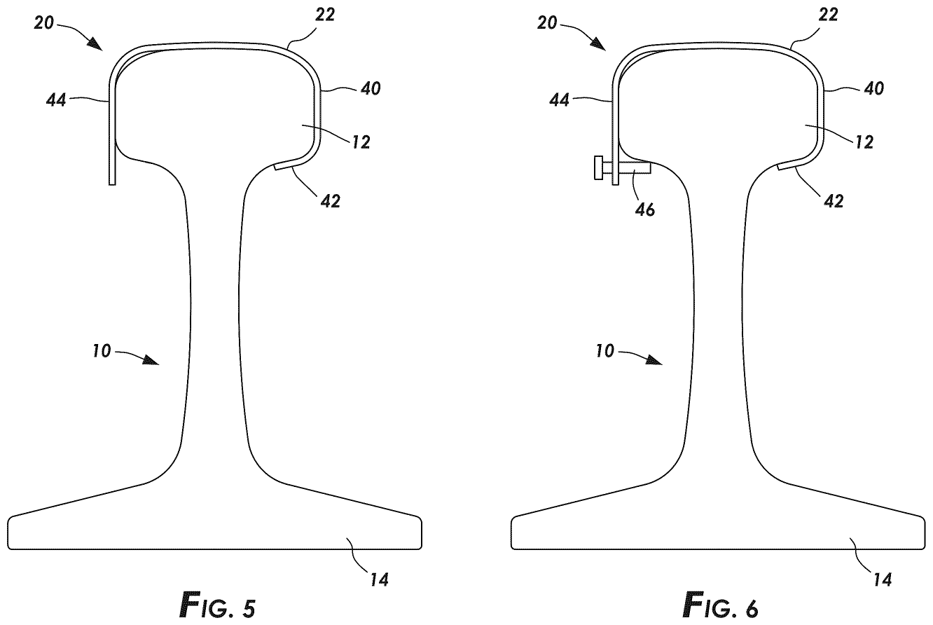

The device 20 can be removably secured to the rail 10 by any of a variety of attachment mechanisms, such as a clamp mechanism or magnetic fasteners. In the embodiment depicted in FIG. 5, the profile of the device 20 wraps around the bottom of the rail head 12 on the gage side and/or the field side of the rail head 12 to create an interference fit with the rail head 12. In this embodiment, a first side member 40 extends downward from the upper surface 22 along a side of the rail head 12 with a lip 42 extending along the underside of the rail head 12. A second side member 44 extends downward from the upper surface 22 along the opposite side of the rail head 12. A bottom opening between the first and second side members 40, 44 receives and removably secures the device 20 to the rail 10 by an interference fit, with the upper surface 22 of the device 20 seated over the rail head 12.

In this embodiment where the device 20 is fixed to the rail 10 by an interference fit, the longer the device 20, the greater the force fixing the device 20 to the rail 10. However, the device 20 will tend to twist under the impact force exerted by the wheel 50. The longer the device 20, the smaller the torsional stiffness. The length of the device 20 has been found to have an optimal range of about 4 to 6 inches, which makes the device 20 adhere to the rail 10 more stably.

Alternatively, the device 20 may extend to the base 14 of the rail 10 along the field side of the rail and be removably secured to the flange of rail base 14 by a clamp mechanism, bolt or fastener 46, as shown in FIG. 6, or by another mechanical securement. This embodiment may be more reliable and offer greater security.

To summarize, the simulated defect of the device 20 has a contour designed to provide consistent and repeatable vertical impact load events at desired locations on a railroad track. The present device 20 does not cause damage to the rail 10, such as might result from creating a weld bead directly on the rolling surface of the wheel 50 or rail 10. The present device 20 does not derail the train. The present device 20 also does not cause damage to the railroad wheel 50 or rail 10, and thus is suitable for being transversed by instrumented wheel sets, which carry costly and sensitive wheel/rail force transducers. The present device 20 is relatively inexpensive, easily replaced as needed between successive test runs, and portable to any desired location along the railroad track 10 where a wheel/rail rolling impact is needed for tests. Ease of replacement is also important because the present device will deform to some degree when train wheels 50 pass over it during testing. In the preferred embodiment, a thin sheet of material, such as high-strength sheet steel, is shaped to conform the upper surface 22 of the device 20 with the profile of the rail head 12. This inexpensive device can be accurately placed at any desired location along the length of the rail 10 to provide a controlled magnitude input force, including impulsive input forces, and is easily replaceable between test runs.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A device for exerting a controlled impact load on the wheel of a rail vehicle, said device comprising:
a thin upper surface contoured to conform with the head of a rail;
a simulated defect in the upper surface to exert a predetermined impact load on the wheel of a rail vehicle rolling over the device on a rail; and
an attachment mechanism removably securing the device to a rail with the upper surface of the device covered a selected portion of the rail head.

2. The device of claim 1 wherein the attachment mechanism further comprises:
a first side member extending downward from the upper surface along a side of the head of a rail with a lip extending along the underside of the head of the rail;
a second side member extending downward from the upper surface along the opposite side of the head of the rail; and
a bottom opening between the first and second side members for receiving and removably securing the device to a rail by an interference fit, with the upper surface of the device seated over the head of the rail.

3. The device of claim 1 wherein the attachment mechanism further comprises:
a side member extending downward from the upper surface along the field side of the head of a rail; and
a clamp attached to the side member removably engaging the rail.

4. The device of claim 3 wherein the clamp engages the base of the rail.

5. The device of claim 1 wherein the attachment mechanism further comprises a magnetic fastener.

6. The device of claim 1 wherein the upper surface has a leading edge with a nominal thickness.

7. The device of claim 6 wherein the simulated defect further comprises a ramp extending upward from the leading edge along the upper surface.

8. The device of claim 1 wherein the simulated defect further comprises the leading edge of the upper surface having a predetermined thickness to exert an impact load on the wheel of the rail vehicle.

9. The device of claim 1 wherein the simulated defect further comprises a raised bump on the upper surface.

10. The device of claim 1 wherein the upper surface and side members are formed from a single thin sheet of material.

11. The device of claim 1 wherein the device has a length in the range of 4 to 6 inches.
